(19) United States
(12) Patent Application Publication
(10) Pub. No.: US 2006/0100046 A1
(43) Pub. Date: May 11, 2006

(54) Image forming apparatus

(75) Inventor: Yasuhiko Fuse, Numazu-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/258,199

(22) Filed: Oct. 26, 2005

(30) Foreign Application Priority Data
Nov. 8, 2004 (JP) 2004-323760

(51) Int. Cl. F16H 7/08; F16H 7/22

(52) U.S. Cl. 474/101; 474/87

(57) ABSTRACT

The image forming apparatus includes an endless belt, a first tensing member having a first and second end portions, wherein the first and second end portions of said first tensing member are positioned in a direction orthogonal to a direction in which said first tensing member guides movement of said endless belt, a guide member, and a second tensing member positioned next to said first tensing member on a downstream side in a belt rotation direction to said first tensing member and for putting said endless belt on with tension from an internal surface of said endless belt, wherein when said endless belt deviates toward a second end portion side, the first end portion of the first tensing member moves by said endless belt in a direction from an external surface of the belt to an internal surface of said endless belt, and wherein when the first end portion moves in a direction from an external surface of the belt to an internal surface of said endless belt, the first end portion moves in a direction away from said second tensing member by said guide member. It achieves to preventing an endless belt from deviating and meandering more effectively than before.

### BACKGROUND OF THE INVENTION

1. Field of the Invention

The present invention relates to an image forming apparatus using an endless belt and particularly to a structure for restraining the endless belt from deviating in the width direction of the belt or from meandering while the belt is being driven.

2. Related Background Art

In recent years, an image forming apparatus has been developed using a photosensitive member belt or an intermediate transfer member belt to improve the conveyability of toner images, and using an endless belt as a recording material conveyance mechanism to improve the conveyability of recording material.

The above-mentioned image forming apparatus using the endless belt can improve a number of functions, however, is indispensable to means of inhibiting generation of deviation from a reference track of the endless belt or meandering during driving operation.

One of possible causes for dislocation due to deviation of the endless belt is that misalignment occurs between members for putting the endless belt on with tension. However, under the present circumstances, misalignment improvement has its limitations and, if consideration of manufacturing variances, secular changes and component tolerances will cause difficult control, including them on main body side. Contraction or expansion of the belt due to a temperature rise in an apparatus changes a belt peripheral length and belt tension varies with the environmental condition, and an unbalanced belt tension due to a difference between left and right peripheral lengths unique to the belt causes deviation while the belt is running.

One of conventional image forming apparatuses is provided with a shaft tilt angle correction device for changing at least one tilt of a shaft of a tensing roller and a deviation thereof when a deviation or a meander is detected, using sensors for detecting belt position and speed. However, such a conventional image forming apparatus has disadvantages such as enlargement and complexity of the whole apparatus by unavoidable attachment of electric components and the like.

### SUMMARY OF THE INVENTION

In view of the aforementioned problems, an object of the present invention is to prevent an endless belt from deviating and meandering with a simple structure more effectively than before.

Another object of the present invention is to provide an image forming apparatus including an endless belt capable of rotatingly moving, a first tensing member for putting the belt on with tension and guiding the movement of the belt, wherein both end portions of the first tensing member in a direction orthogonal to a direction in which the first tensing member guides the movement of the belt are a first end portion and a second end portion, a guide member for guiding the movement of the first end portion; and a second tensing member positioned next to the first tensing member on the downstream side in a belt rotation direction and for putting the belt on with tension from an internal surface of the belt, wherein as the belt approaches a second end portion side, the first tensing member on the first end portion side moves in such a direction as to run inward from an external surface of the belt through the belt; and wherein as the first end portion moves in such a direction as to run inward from an external surface of the belt, the first end portion moves in such a direction as to leave the second tensing member through the guide member.

A further object of the present invention is to provide An image forming apparatus including an endless belt capable of effecting a rotation movement; a tensing member having first and second end portions, for putting said endless belt on itself with tension from an internal surface of said endless belt and guiding the rotation movement of said endless belt, wherein the first and end portions of said first tensing member are positioned with respect to a direction orthogonal to a direction in which said first tensing member guides the rotation movement of said endless belt; a guide member for guiding the rotation movement of the first end portion; and wherein when said endless belt deviates toward a second end portion side, the first end portion of said tensing member moves by said endless belt in a direction from an external surface of said endless belt to an internal surface of said endless belt; and wherein when the first end portion moves in a direction from an external surface of said endless belt to an internal surface of said endless belt, the first end portion moves in a direction opposite to a direction of the rotation movement of said endless belt.

A still further object of the present invention will be apparent from the following description.

### BRIEF DESCRIPTION OF THE DRAWINGS

FIG. 1 is a perspective view illustrating the operation of belt deviation regulation in a first embodiment according to the present invention;

FIGS. 2A and 2B are respectively a partially detailed view illustrating the operation of belt deviation regulation in a first embodiment according to the present invention;

FIG. 3 is a partially detailed view illustrating the operation of belt deviation regulation in a first embodiment according to the present invention;

FIG. 4 is a view illustrating a tensing method for an endless belt in a first embodiment according to the present invention;

FIG. 5 is a schematic sectional view illustrating a color laser beam printer of an example of the image forming apparatus according to a first embodiment of the present invention;

FIG. 6 is a schematic sectional view illustrating a color laser beam printer of an example of the image forming apparatus according to a second embodiment of the present invention;

FIGS. 7A and 7B are partially detailed views illustrating the operation of the belt deviation regulation of the image forming apparatus according to a third embodiment of the present invention; and

FIG. 8 is a schematic sectional view illustrating a color laser beam printer of an example of the image forming apparatus according to a fourth embodiment of the present invention.

### DESCRIPTION OF THE PREFERRED EMBODIMENTS

The image forming apparatus according to the present invention will be described in detail with reference to the accompanying drawings.

### First Embodiment

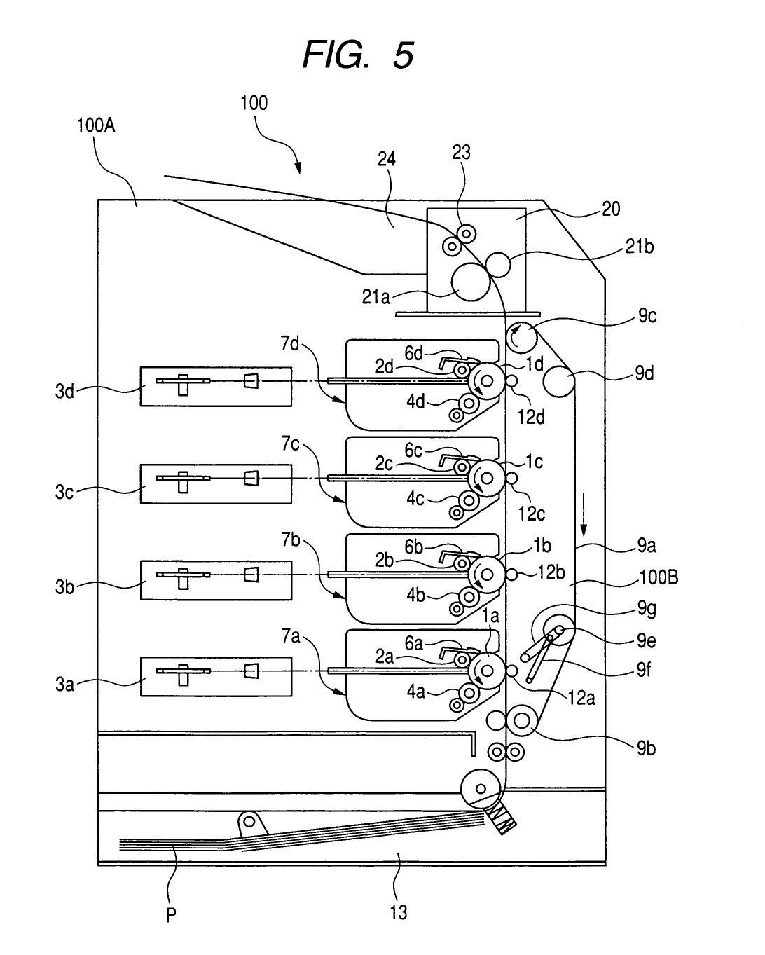

Referring now to the accompanying drawings, First Embodiment of the present invention is described below. FIG. 5 is a schematic sectional view illustrating a color laser beam printer of an example of the image forming apparatus according to First Embodiment of the present invention.

In FIG. 5, a reference numeral 100 denotes a color laser beam printer, hereinafter referred to a “printer”. The printer 100 is provided with an image forming section 100A having mainly four photoconductive drums 1a, 1b, 1c, 1d as image bearing members and four scanner units 3a, 3b, 3c, 3d constituted of a rotary polygon mirror and a reflecting mirror respectively. The image forming section 100A forms latent images on the four photoconductive drums 1a, 1b, 1c, 1d, each surface of which is uniformly charged by charging rollers 2a, 2b, 2c, 2d. The latent images are formed on the surface of the photoconductive drums 1a, 1b, 1c or 1d by making the scanner units 3a, 3b, 3c, 3d apply light in accordance with image information. Each of the latent images is then developed by developing sleeves 4a, 4b, 4c, 4d fitted on developers 7a, 7b, 7c, 7d. This forms visible images of each color of yellow, cyan, magenta and black on the photoconductive drums 1a, 1b, 1c or 1d. Reference numerals 12a, 12b, 12c, 12d are transfer rollers constituting a transfer section by a pressure contact through an endless belt 9a described later. Reference numerals 6a, 6b, 6c, 6d are cleaning means.

In FIG. 5, a reference numeral 13 denotes a paper cassette for storing recording material P as paper sheets and the recording material P stored in the paper cassette 13 is delivered by a paper feeding roller. A reference character 9a is an endless belt for conveying the recording material P to each transfer section. The recording material P conveyed from the paper cassette 13 is placed on the endless belt 9a and is conveyed to each transfer section one after another. Visible images (toner images) of each color of yellow, cyan, magenta and black formed on the surface of each of the photoconductive drums are transferred one after another. The recording material P transferred with visible images one after another is heated and pressurized by a heating roller 21a and a pressure roller 21b of a fixing part 20, so that transferred toner images are permanently fixed. The recording material P fixed with the toner images in this way is then delivered to a receiving tray 24 by a paper exit roller 23.

In this embodiment, the endless belt 9a is formed out of an approx. 65 μm thick film-shaped member having not larger than volume resistivity of 10¹² Ωcm. The volume resistivity is a value obtained by applying 100V with a high resistance meter R8340 manufactured by ADVANTES Co. Ltd. The endless belt 9a is put on with tension by a belt drive 100B constituted of a driving roller 9c, a belt deviation regulation driven roller 9b, hereinafter referred to as a “regulation roller”, a driven roller 9d and a tension roller 9e. The endless belt 9a is so arranged as to rotate in the direction of an arrow (clockwise in Figure). Both end portions of each of all the rollers 9b, 9c and 9d are rotatably retained on bearings provided at a main body frame (not illustrated) of the belt drive 100B. Rotating shafts of the rollers 9b, 9c, 9d and 9e are disposed so as to be substantially parallel with a direction orthogonal to the rotation direction of the endless belt 9a. The driving roller 9c is formed out of a metallic roller, on a surface layer thereof, having a rubber layer of which frictional coefficient is high against an internal surface of the endless belt 9a. The driving roller has an outside diameter set at approx. 24 mm and is structured so as to be rotated at a predetermined speed in the direction of an arrow by a drive source. The driven roller 9d is constituted of a metallic roller, for example, made of SUS or the like.

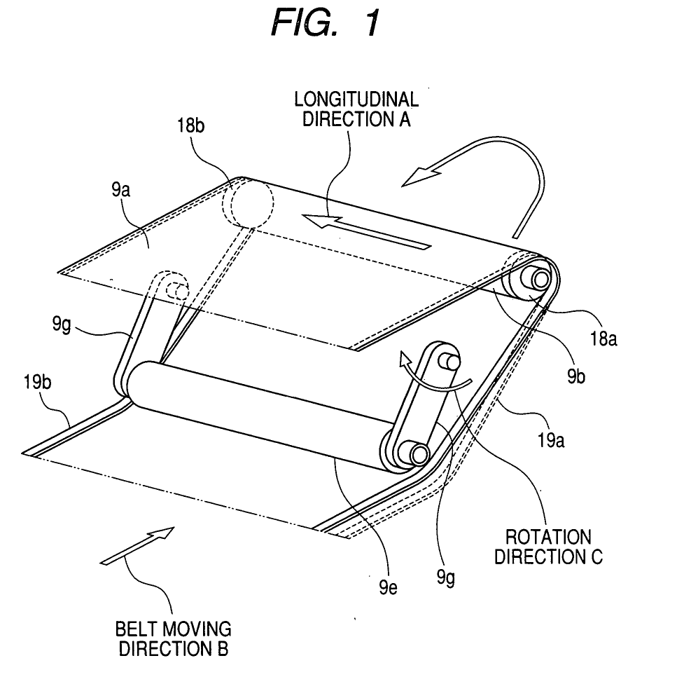

On the other hand, on both end portions of the regulation roller 9b, as illustrated in FIG. 1, there are disposed protruding belt-deviation regulation members, hereinafter referred to as a “belt regulation member”, to avoid deviation, meandering or the like of the endless belt 9a. The belt regulation members 18a, 18b are rotatably provided, the rotational center line of which is common to that of the regulation roller. The internal end portions of the belt regulation members 18a, 18b come into approximate contact with the side end surface of the regulation roller 9b and are molded so as to be almost the same diameter as a contact surface with the regulation roller 9b. If deviation or meandering occurs at the endless belt 9a, the protruding regulation guides 19a, 19b formed at both ends of the inner-periphery surface of the endless belt 9a abuts against the side surface portions of the belt regulation members 18a, 18b. In the belt regulation members 18a, 18b, each of the regulation guides (ribs) 19a, 19b has a tapered portion on an abutting (latching) portion thereof. Preferably, as a material of each of the belt regulation members 18a, 18b, a material with a low frictional efficiency, for example, a material with high slidability such as POM, is used. On the other hand, as a material of each of the regulation guides 19a, 19b, a rubber material is used which is excellent enough to bear bending stress applied when the endless belt 9a is wound around the respective rollers 9b, 9c, 9d and 9e as belt tensing members.

The tension roller 9e uses an aluminum pipe, of which surface roughness is a center-line average roughness (Ra) conforming to JIS B0601 and, as the roughness, 1.6 μm is selected. This makes gripping capability against the endless belt 9a appropriate and, in this embodiment, a coefficient of static friction against an internal surface of the endless belt 9a of at least 0.15 is ensured. It is sufficient that appropriate gripping capability is ensured between the aluminum pipe and the internal surface of the endless belt 9a. Accordingly, the coefficient of static friction is 0.20 or 0.25 which is more than 0.15 yields favorable results in the same way. The coefficient of static friction was measured by engaging the endless belt 9a between horizontal two shafts, placing the belt therebetween so that the internal surface thereof may be turned up and placing a tension roller 9e on the belt. A belt fixing method is adjusted so that the endless belt 9a may be deflected by the dead weight of the tension roller 9e and, prior to measurement, adjustment was made so that belt winding amount may be the same as the winding amount by the tension roller 9e in the image forming apparatus. The tension roller 9e was placed in such a manner that parts were removed from a main body, and the coefficient of static friction was calculated from an axial pull force and the weight of the tension roller 9e. If the coefficient of static friction is 0.10, gripping capability was low, which impaired the response of deviation control.

The tension roller 9e is always urged in a such a direction as to pull the endless belt 9a by a spring 9f and rotates interlocking with conveyance by belt rotation, so as to completely guide movement of the endless belt 9a. On each of both end portions of a shaft of the tension roller 9e, there is attached an arm-shaped displacement supporting member 9g also serving as a bearing of the tension roller 9e to individually and independently oscillate both the end portions of the tension roller 9e. The displacement supporting member 9g functions as a guide member for guiding movement of the tension roller 9e.

While the recording material P is being conveyed by the endless belt 9a, the endless belt 9a sometimes deviates or meanders. There are next described the regulation operations of the belt regulation members 18a, 18b against deviation or meandering of the endless belt 9a and the functions of the tension roller 9e.

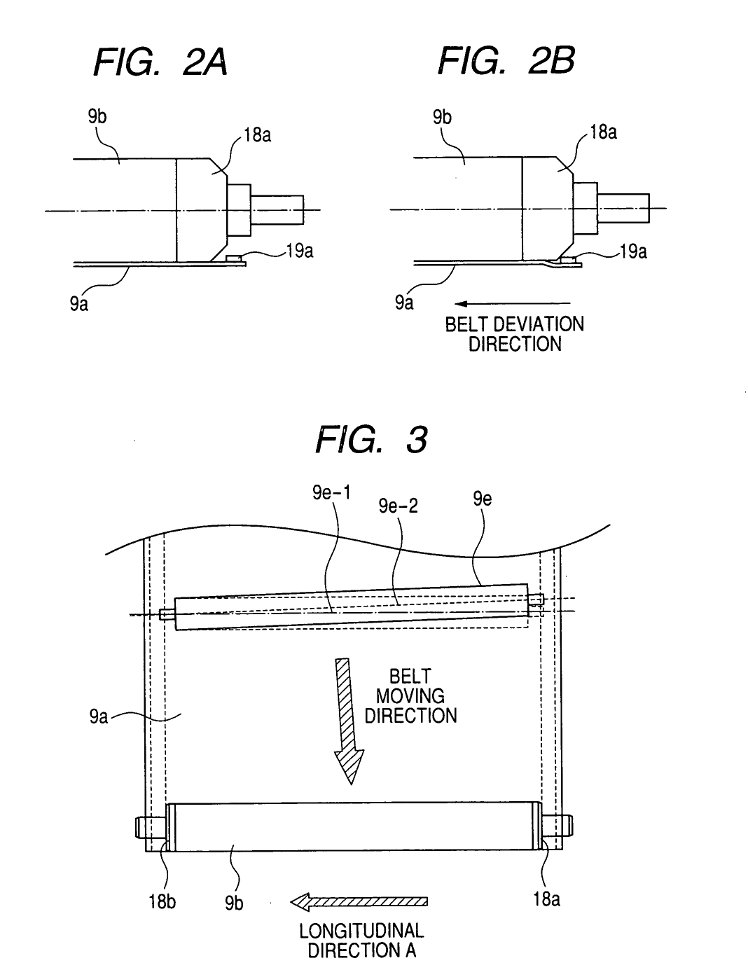

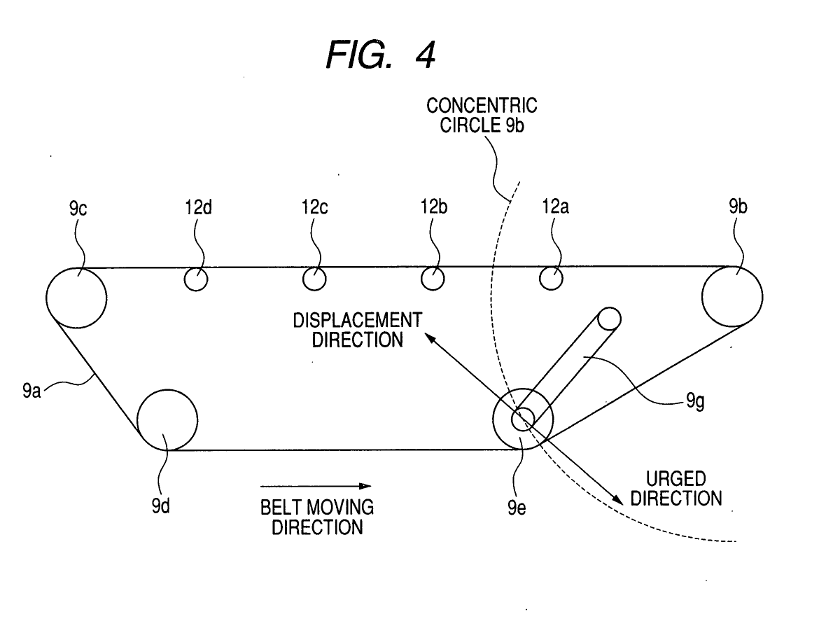

For example, assuming that the endless belt 9a moves in a longitudinal direction A of the regulation roller 9b (in a direction orthogonal to the rotation direction of the endless belt 9a) as illustrated in FIG. 1 during the rotating and moving process of the endless belt 9a, the regulation guide 19a fitted on the endless belt 9a abuts against the belt regulation member 18a of the regulation roller 9b to be regulated. The width-direction length of each of the rollers 9c, 9d, 9e (not illustrated) as a tension control rotation member with the belt engaged except the deviation regulation roller is shorter than that of the regulation roller 9b, therefore the regulation guide 19a has no abutment. If the tension of the endless belt 9a is set to be large or rigidity is high, a force applied to the regulation roller 9b in the longitudinal direction A, that is, a deviation force becomes high, so that the regulation guide 19a attempts to climb over the belt regulation member 18a (FIGS. 2A and 2B). If the regulation guide 19a advances in such a direction as to climb the tapered portion on the belt regulation member 18a, the belt peripheral length on the side where the endless belt 9a attempts to climb over apparently becomes shorter by an amount of the thickness of the regulation guide 19a. As a result, on the side where the endless belt attempts to climb over, the tension roller 9e is pushed into in an opposite direction to an urging direction, that is, in a direction that the tension roller enters the inside of the endless belt, and tilts significantly relative to other tensing rollers 9b, 9c and 9d. Referring next to FIG. 4, there is described the behaviors of an end portion of the tension roller 9e on the side where the end portion enters the inside of the endless belt 9a, of the end portions of the tension roller 9e.

The end portion of the tension roller 9e when the end portion enters the inside of the endless belt 9a is on an oscillating path of an arm type retaining member 9g. The path gets out of an arc passing through the axial center of the tension roller 9e with the axial center of the regulation roller 9b on the downstream side taking as the center thereof. To get out of the arc means an increase in a distance to the regulation roller 9b. When one end portion of the tension roller 9e gets out of the arc, an angle of the regulation roller 9b to the tension roller 9e changes. At this time, an inclination of the tension roller 9e is displaced from 9e-1 to 9e-2 in FIG. 3. This means that a vector perpendicular to a line 9e-2 on which the tension roller 9e with the displaced inclination comes into contact with the endless belt 9a has a vector in an opposing direction to the deviation direction of the belt, except a vector in the rotation direction of the belt. A vector in such a direction that the tension roller 9e delivers the belt has a vector in an opposing direction to the deviation direction of the endless belt 9e. Accordingly, the belt is moved in such a direction as to correct the belt deviation. Especially, in the case of this embodiment, because the gripping capability of the tension roller 9e is improved, the belt is pushed out more completely in a perpendicular direction to the line 9e-2 on which the tension roller 9e with the displaced inclination comes into contact with the belt 9a.

In the aforementioned description, it is observed with respect to the relative position relationship between the tension roller 9e and the regulation roller 9b. This, in another view, implies that the tension roller 9e can moves in a direction opposite to a direction of the rotation movement direction of the belt 9a in the case that an end part of the tension roller 9e comes into the inside (the internal surface side) of the belt 9a.

In this embodiment, the arm type retaining member 9g disposed at both the end portions of the tension roller 9e has a space of approx. 50 mm from a rocking and rotating fulcrum of the retaining member to a tension roller bearing section. The regulation guides 19a, 19b have a cross section having a rectangular shape of 4 mm in width and 1.5 mm in height respectively and are jointed to each other along the inner periphery of the endless belt 9a. Assuming that the regulation guides 19a, 19b completely climb over the belt regulation members 18a, 18b disposed on both ends of the regulation roller 9b, the amount by which the tension roller is pushed into in an opposite direction to an urging direction thereof is approximately 8 mm. At this time, an inclination of the tension roller 9e is displaced from 9e-1 to 9e-2 in FIG. 3 and an inclined angle thereof is approx. 0.5 degrees.

A vector in a direction opposing to a deviation direction of the endless belt 9a increases proportionately with a deviation amount of the belt. In case of the deviation of the endless belt 9a due to a sudden factor, the vector timely acts as a force of returning the climbed-over regulation guide 19a to a regular guide position. When a deviation force of the endless belt 9a is small, an inclination of the tension roller 9e becomes small. This includes belt deviation due to, for example, a difference in the peripheral length between both ends of the endless belt 9a in the longitudinal direction, production variance caused by tensing roller alignment failure or secular changes. In this case, the regulation guide 19a gradually climbs over the belt regulation member 18a, so that a vector opposing to a belt deviation direction gradually becomes larger. During this process, the position of the endless belt 9a is displaced for stability until a good balance is kept between the belt deviation force and belt restoring force opposing to the belt deviation force. For example, even if a peripheral length of the endless belt 9a is under a slightly different status in a longitudinal direction, the belt position transits for stable driving until a good balance is kept between the belt deviation force and the belt restoring force.

This configuration is compatible with the installation status of a main body. Even if the peripheral length of the endless belt 9a has no differences in a longitudinal direction, belt deviation may occur. One of possible causes is, for example, wrong printer location. The printer location is at the discretion of a user, however, the user does not always locate a printer on a flat surface. In this case, the printer itself has some distortion, maintaining the initial state is difficult to maintain for the roller alignment of a belt moving apparatus installed inside the main body. However, under such a status, the belt deviation correction mechanism according to this embodiment comes into action, thus providing stable belt driving. This is because the tension roller 9e exhibits a similar function to a function that automatically adjusts alignment.

Advantages of the belt deviation correction mechanism according to this embodiment have no particularly limited stable belt driving position, and the belt deviation correction mechanism can timely meet.

As described above, this embodiment can prevent the endless belt 9a from deviating and meandering, thus achieving high durability and stable driving performance for the endless belt.

### Second Embodiment

A case where belt urging is performed by using an arm type retaining member of retaining the tension roller 9e has been described above as an example. This embodiment employs a system of capable of sliding operations only in a belt urged direction and belt urging by a helical compression spring through the tension roller 9e as a retaining member for retaining the tension roller 9e. The sliding portion guides movement of the tension roller 9e. However, the sliding portion is of a single-side independent type.

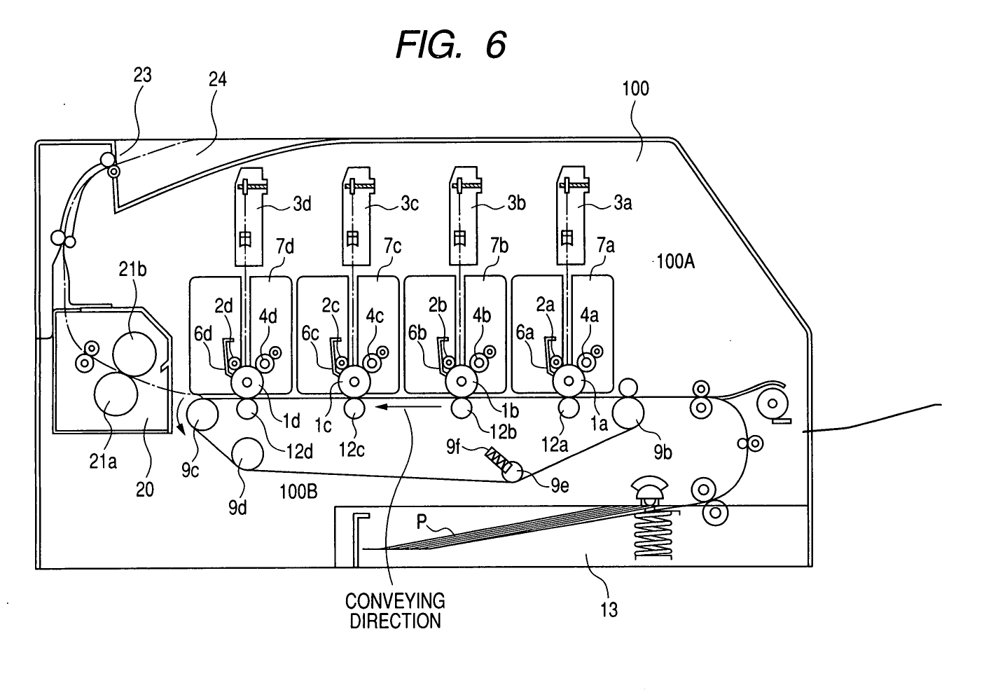

FIG. 6 is a schematic sectional view illustrating a color laser beam printer of an example of the image forming apparatus according to Second Embodiment of the present invention. In FIG. 6, the same numeral/character as in FIG. 5 denotes the same or corresponding section/portion. The tension roller 9e is retained so as to be slidable along a belt urged direction with a sliding groove formed on a main body frame (not illustrated) of the belt drive means 100B. Moreover, the tension roller 9e is designed so as to urge the endless belt 9a with the helical compression spring 9f as urging means. The retaining method of the tension roller 9e is different, however, if deviation occurs in the endless belt 9a, the belt regulation member 18a abuts against the regulation guide 9a, so that the belt peripheral length on the abutting side apparently becomes shorter. The tension roller 9e is pushed into the opposite side to the urging direction by a shortened amount, thus attaining a result of restraining belt deviation. Under this state, the end portion of the tension roller 9e on the belt deviation side gets out of the arc passing through the axial center of the tension roller 9e taking the axial center of the regulation roller 9b as the center thereof. In the same way as for First Embodiment, belt deviation control can be achieved.

### Third Embodiment

The above embodiments describe that the belt regulation members 18a, 18b are disposed on both ends of the regulation roller 9b for regulating deviation and meandering of the belt.

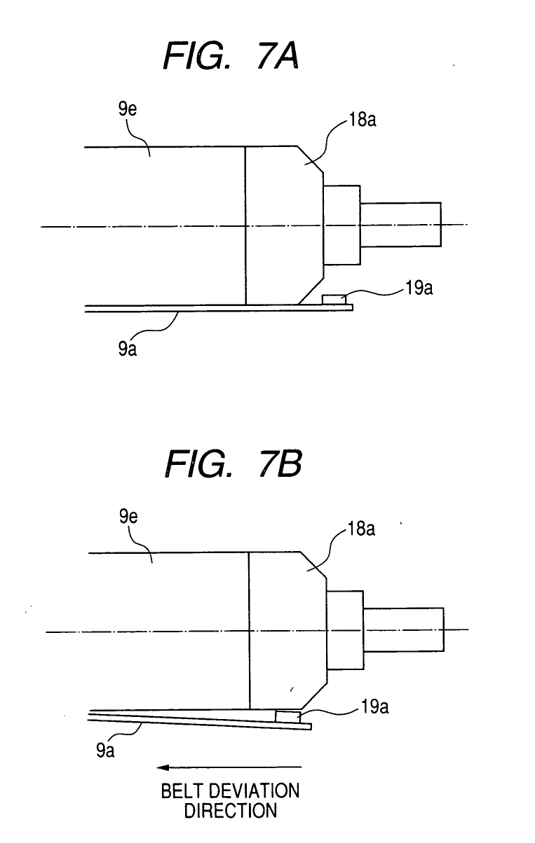

In this embodiment, as illustrated in FIGS. 7A and 7B, the belt regulation members 18a, 18b are disposed on both ends of the tension roller 9e. A length of the tension roller 9e in a longitudinal direction is larger than those of any of other belt tensing rollers so as to be large enough to accommodate in the regulation guides (ribs) of the endless belt 9a. As a result, if the endless belt 9a deviates, the belt regulation member 19a or 19b is so structured as to climb over the end portion of the tension roller 9e. If deviation occurs, either of the belt regulation member 18a or 18b which climbs over the tension roller 9e is pushed into the regulation guide (rib) of the endless belt 9a, so that belt moving force by the tension roller 9e moves the endless belt 9a in such a direction as to restrain belt deviation, as described in First Embodiment. Thus, almost the same effect as that described in First Embodiment can be achieved. In this embodiment, a rubber layer with high m frictional coefficient inside the endless belt 9a is provided on a surface layer of the tension roller 9e, thus increasing the moving force of the transfer belt 9a and the regulation force for deviation regulation by the tension roller 9e.

### Fourth Embodiment

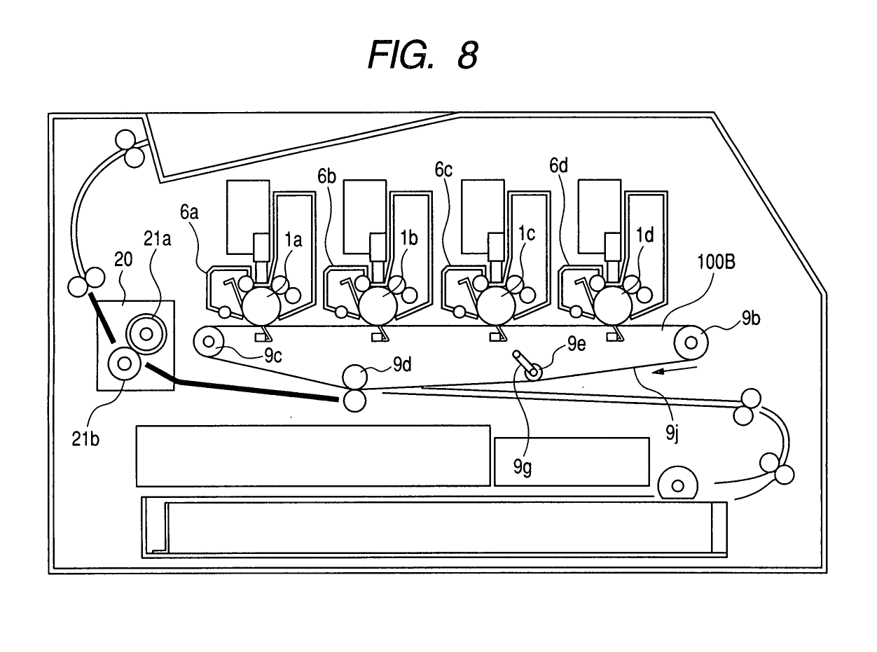

All the above embodiments are intended for conveyance of recording material by the endless belt 9a. However, the image forming apparatus according to this embodiment is provided with an endless intermediate transfer belt 9j in place of the endless belt 9a for conveying recording material. FIG. 8 is a schematic sectional view illustrating a color laser beam printer as an example of the image forming apparatus according to Fourth Embodiment of the present invention. Detailed descriptions of respective sections are omitted. In FIG. 8, the same reference numerals/characters as those in FIG. 5 denote the same or corresponding sections/portions.

In the same way as other embodiments, this embodiment uses the belt drive 100B. However, as described above, the intermediate transfer belt 9j owned by the belt drive 100B receives toner images directly on the intermediate transfer belt 9j from each of the photoconductive drums 1a, 1b, 1c, 1d. Colored images are prepared by superimposing one toner image upon another on the intermediate transfer belt 9j. In other words, this is an image forming apparatus using intermediate transfer.

Both ends of the tension roller 9e in the belt drive 100B illustrated in FIG. 8 are independetly retained by an oscillatable arm 9g respectively. If the intermediate transfer belt 9j deviates, the belt peripheral length on the opposite side to the side where the intermediate transfer belt 9j deviates apparently becomes shorter. As a result, the end portion of the tension roller 9e on the opposite side to the side where the intermediate transfer belt 9j deviates is pushed into in an opposite direction to an urged direction, that is, in such a direction as to enter the inside of the intermediate transfer belt 9j and inclines largely relative to other tensing rollers 9b, 9c, 9d. Then the tension roller 9e moves in such a direction as to get out of an arc passing through the axial center of the tension roller 9e with the axial center of the tensing roller 9d on the downstream side to the tension roller 9e serving as the center thereof, thus correcting the deviation of the intermediate transfer belt 9j.

Consequently, the image forming apparatus according to this embodiment is capable of preventing a belt from deviating and meandering.

The foregoing embodiment illustrates a printer as an example of the image forming apparatus, but is not limited to the printer. Other examples of this embodiment includes other image forming devices such as a copying machine and a facsimile machine or other image forming devices such as a multifunction machine with these functions combined. Furthermore, application of the present invention to an image forming device using a photoconductive drum belt as an endless belt provides the same effect.

As many apparently widely different embodiments of the present invention may be made without departing from the spirit and scope thereof, it is to be understood that the present invention is not limited to the specific descriptions and drawings thereof except as defined in the appended claims.

This application claims priority from Japanese Patent Application No. 2004-323760 filed on Nov. 8, 2004, which is hereby incorporated by reference herein.

What is claimed is:

1. An image forming apparatus comprising:
an endless belt capable of rotating;
a first tensing member having first and second end portions, for putting said endless belt on itself with tension from an internal surface of said endless belt and guiding movement of said endless belt, wherein the first and second end portions of said first tensing member are positioned in a direction orthogonal to a direction in which said first tensing member guides movement of said endless belt;
a guide member for guiding movement of the first end portion; and
a second tensing member positioned next to said first tensing member on a downstream side in a belt rotation direction to said first tensing member and for putting said endless belt on with tension from an internal surface of said endless belt,
wherein when said endless belt deviates toward a second end portion side, the first end portion of the first tensing member moves by said endless belt in a direction from an external surface of the belt to an internal surface of said endless belt; and
wherein when the first end portion moves in a direction from an external surface of the belt to an internal surface of said endless belt, the first end portion moves in a direction away from said second tensing member by said guide member.

2. An image forming apparatus according to claim 1, wherein a line connected between the first end portion and the second end portion is substantially parallel to a line orthogonal to the rotation direction of said endless belt.

3. An image forming apparatus according to claim 1, further comprising another guide member for guiding movement of the second end portion,
wherein when said endless belt deviates the first end portion side, the second end portion of said first tensing member moves in a direction from an external surface of said endless belt to an internal surface of said endless belt; and wherein when the second end portion moves in a direction from an external surface of said endless belt to an internal surface of said endless belt, the second end portion moves in a direction away from the second tensing member by said another guide member.

4. An image forming apparatus according to claim 3, wherein the first end portion and the second end portion are movable individually.

5. An image forming apparatus according to claim 1, wherein said endless belt has a protruding part on an internal surface of said endless belt, when the protruding part abuts on a surface of one of said first tensing member with which the protruding part contacts, one of the first and second end portions of the first tensing member moves in a direction from an external surface of said endless belt to an internal surface of said endless belt.

6. An image forming apparatus according to claim 1, wherein a coefficient of static friction between said endless belt and the first tensing member in a direction along a line connecting between the first end portion and the second end portion is equal to or more than 0.15.

7. An image forming apparatus according to claim 1, wherein the more the first end portion moves in a direction from an internal surface of said endless belt to an external surface of said endless belt, the more the first end portion moves in a direction opposite to a direction of the rotation movement of said endless belt.

8. An image forming apparatus according to claim 1, wherein said first tensing member and said second tensing member are rollers respectively having a rotating shaft substantially orthogonal to a rotation direction of said endless belt and the first end portion and the second end portion are positioned on the rotating shaft on the first tensing member.

9. An image forming apparatus according to claim 8, wherein when the first end portion moves in a direction from an external surface of said endless belt to an internal surface, the first end portion moves in a direction away from the rotating shaft of the second tensing member.

10. An image forming apparatus according to claim 1, wherein the belt bears a toner image.

11. An image forming apparatus according to claim 1, wherein said endless belt bears recording material and a toner image is transferred on the recording material.

12. An image forming apparatus comprising:
an endless belt capable of effecting a rotation movement;
a tensing member having first and second end portions, for putting said endless belt on itself with tension from an internal surface of said endless belt and guiding the rotation movement of said endless belt, wherein the first and end portions of said first tensing member are positioned with respect to a direction orthogonal to a direction in which said first tensing member guides the rotation movement of said endless belt;
a guide member for guiding the rotation movement of the first end portion; and
wherein when said endless belt deviates toward a second end portion side, the first end portion of said tensing member moves by said endless belt in a direction from an external surface of said endless belt to an internal surface of said endless belt; and
wherein when the first end portion moves in a direction from an external surface of said endless belt to an internal surface of said endless belt, the first end portion moves in a direction opposite to a direction of the rotation movement of said endless belt.

13. An image forming apparatus according to claim 12, wherein a line connected between the first end portion and the second end portion is substantially parallel to a line orthogonal to the rotation direction of said endless belt.

14. An image forming apparatus according to claim 12, further comprising another guide member for guiding movement of the second end portion,
wherein when said endless belt deviates the first end portion side, the second end portion of said tensing member moves in a direction from an external surface of said endless belt to an internal surface of said endless belt; and wherein when the second end portion moves in a direction from an external surface of said endless belt to an internal surface of said endless belt, the second end portion moves in a direction opposite to a direction of the rotation movement of said endless belt.

15. An image forming apparatus according to claim 14, wherein the first end portion and the second end portion are movable individually.

16. An image forming apparatus according to claim 12, wherein said endless belt has a protruding part on an internal surface of said endless belt, when the protruding part abuts on a surface of one of said tensing member with which the protruding part contacts, one of the first and second end portions of the tensing member moves in a direction from an external surface of said endless belt to an internal surface of said endless belt.

17. An image forming apparatus according to claim 12, wherein a coefficient of static friction between said endless belt and the tensing member in a direction along a line connecting between the first end portion and the second end portion is equal to or more than 0.15.

18. An image forming apparatus according to claim 12, wherein the more the first end portion moves in a direction from an internal surface of said endless belt to an external surface of said endless belt, the more the first end portion moves in a direction opposite to a direction of the rotation movement of said endless belt.

19. An image forming apparatus according to claim 12, wherein said tensing member is a roller having a rotating shaft substantially orthogonal to a rotation direction of said endless belt and the first end portion and the second end portion are positioned on the rotating shaft on the tensing member.

20. An image forming apparatus according to claim 12, wherein the belt bears a toner image.

21. An image forming apparatus according to claim 12, wherein said endless belt bears recording material and a toner image is transferred on the recording material.
